(19) United States
(12) Patent Application Publication
(10) Pub. No.: US 2007/0092429 A1
(43) Pub. Date: Apr. 26, 2007

(54) Methods of preparing carbon-coated particles and using same

(75) Inventors: Zhenhua Mao, Ponca City, OK (US); Mark Carel, Ponca City, OK (US)

Correspondence Address: CONOCOPHILIPS COMPANY, P.O. BOX 2443, BARTLESVILLE, OK, 74004, US

(73) Assignee: ConocoPhillips Company, Houston, TX (US)

(21) Appl. No.: 11/257,221

(22) Filed: Oct. 24, 2005

(51) Int. Cl. H01M 4/58; C01B 31/02

(52) U.S. Cl. 423/445 R; 429/231.8; 423/448

(57) ABSTRACT

A method for the production of carbon-coated particles comprising providing a carbonaceous material, milling said carbonaceous material, and thermal-conditioning said carbonaceous material. A carbon particle having the following characteristics: an average particle size of less than about 30 μm, an aspect ratio of less than about 4, a carbonaceous coating level of from about 1% to about 50% by weight, and a graphitic structure.

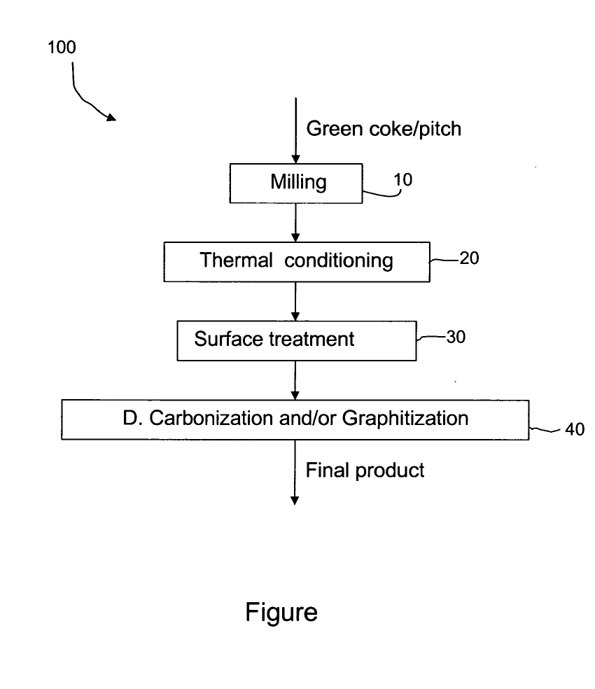

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This disclosure generally relates to methods of production of graphite materials. More specifically, this disclosure relates to methods of producing carbon-coated particles for use as anode materials in electrochemical storage cells.

2. Background of the Invention

The requirements for battery performance are largely dependent on their intended application. For example, batteries for use in hybrid electric vehicles may require a very long life cycle, low cost, high gravimetric densities and high volumetric densities, while batteries for portable devices such as cellular phones and camcorders may have the additional requirement of being lightweight. Materials used for the construction of such batteries play a significant role in the batteries' ability to meet the aforementioned requirements.

Carbon particles such as graphite powders are currently used as the anode material for lithium ion batteries. The initial columbic efficiency of a graphite powder is known to be inversely proportional to the surface area of the graphite powder such that the higher the surface area of the powder, the lower the initial columbic efficiency. For this reason, battery manufacturers typically employ graphite powders having a relatively low surface area. This has resulted in the average particle size of graphite powders used as anode materials being about 20 μm. Such powders may find utility in lithium batteries for lightweight portable devices, however they do not possess the characteristics necessary for their use in high power battery applications such as hybrid electric vehicles. These applications have a high power requirement that necessitates the use of graphite materials having an average particle size of 10 μm or less. In addition, the fabrication of electrodes with such fine powders (i.e having a particle size of 10 μm or less) would be facilitated by such powders having a shape characterized by a low aspect ratio.

Traditional methods for the sizing and shaping of carbon particles such as graphite powders lack the ability to produce small particles of desirable shape and quality. For example, traditional mechanical methods such as milling may produce particles of 10 μm or less, but the particles tend to be irregular and lack the desired shape. Traditional chemical and physical methods such as mesophase pitch precipitation and vapor phase growth may also produce small particles but the resulting powder would have a low crystalline structure, resulting in low specific capacity. In addition the use of these chemical and physical methods often involve complicated and slow processes resulting in a high production cost.

Thus there exists a need for a method of producing carbon particles suitable for use as the anode material in batteries.

### BRIEF SUMMARY OF SOME OF THE PREFERRED EMBODIMENTS

Disclosed herein is a method for the production of carbon-coated particles comprising providing a carbonaceous material, milling said carbonaceous material, and thermal-conditioning said carbonaceous material. Further disclosed herein is a carbon particle having the following characteristics: an average particle size of less than about 30 μm an aspect ratio of less than about 4, a carbonaceous coating level of from about 1% to about 50% by weight, and a graphitic structure.

The foregoing paragraphs outline the features and technical advantages of the present disclosure in order that the detailed description that follows may be better understood. Additional features and advantages of the invention will be described hereinafter. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the scope of the invention as set forth in the appended claims.

### BRIEF DESCRIPTION OF THE DRAWING

For a detailed description of the preferred embodiments of the invention, reference will now be made to the accompanying drawing, which is a process flow diagram for production of carbon-coated particles.

### DETAILED DESCRIPTION OF THE PREFERRED EMBODIMENTS

Disclosed herein are methodologies for the production of carbon-coated particles. These particles may be employed as the anode material for the construction of electrochemical storage cells, alternatively lithium batteries, and alternatively high-powered lithium batteries. In an embodiment, the methodologies disclosed herein result in the production of carbon-coated particles having improved characteristics such as a low aspect ratio and high capacity when employed as the anode material for high-power lithium batteries. One embodiment 100 of the present methods is shown in the FIGURE and comprises at least the steps of milling, thermal-conditioning, surface treatment and carbonization or graphitization. It is to be understood that these process steps are carried out independently, thus; any combination of these steps may be contemplated. In a preferred embodiment, the process for the production of carbon-coated particles may be carried out in the order described herein.

According to certain embodiments, the method 100 initiates with the milling of a carbonaceous material in step 10. The carbonaceous material may be any carbon-yielding material having a fixed carbon content of greater than about 25 wt. %, alternatively greater than about 50 wt. %, and alternatively greater than about 60 wt. % when heated in an inert environment at temperatures of greater than about 1000° C. for from about 0.5 hours to about 5 hours. The inert environment may comprise an inert gas such as nitrogen, argon or combinations thereof. Suitable carbonaceous materials will not significantly melt or fuse when heated to 1000° C. These carbonaceous materials may be pulverulant, solid, or porous carbon-yielding materials consisting of organic polymers, petroleum pitches, coal tar pitches, calcined petroleum cokes, uncalcined petroleum cokes, highly crystalline cokes, coal tar cokes, synthetic graphites, natural graphites, soft carbons derived from organic polymers, soft carbons derived from natural polymers or combinations thereof. In certain embodiments, the carbonaceous materials comprise uncalcined petroleum or tar cokes, sometimes referred to as “green coke.”

As used herein, “pitch” refers to a residue derived from pyrolysis of organic material or tar distillation that is solid at room temperature and consists primarily of a complex mixture of aromatic hydrocarbons and heterocyclic compounds. As used herein “coke” refers to coal tar cokes and “petroleum coke,” or the final product of thermal decomposition in the condensation process in catalytic cracking. Because coke is the carbonization product that remains after heating high boiling hydrocarbons to temperatures below 900 K, it may contain hydrocarbons that can be released as volatiles during subsequent heat treatments at temperatures up to 1600 K.

As used herein, a “calcined coke” refers to a material obtained by heat treatment of raw or green coke material to about 1600 K, resulting in the calcined coke having a hydrogen content of less than about 0.1 wt. %.

“Milling” herein refers to a process of bulk solid size reduction. Examples of suitable milling methods include but are not limited to impact milling, attrition milling, jet milling, ball milling, fine media milling, and knife milling. Any mechanical milling method may be employed, so long as it is effective for achieving the desired particle size reduction. Such milling methods, conditions and equipment are known to one of ordinary skill in the art.

In preferred embodiments, after milling the carbonaceous materials have an average particle size of less than about 30 μm, alternatively of less than about 20 μm, alternatively less than about 15 μm, and alternatively less than about 10 μm. Particles that have been processed through the step represented as block 10 in the FIGURE are hereafter referred to as milled particles.

Referring again to the FIGURE, the method then proceeds to block 20, wherein the milled particles are subjected to thermal-conditioning. Thermal-conditioning herein refers to a thermal treatment designed to increase the carbon content of the material and to condition the material such that it forms a better-oriented crystalline structure and is more resistant to oxidation such as for example by exposure to oxygen gas than an otherwise identical milled particle that has not been thermal-conditioned. Such conditioned carbon particles may optionally be graphitized in a subsequent step. The process of graphitization will be described in detail later in this disclosure. The thermal-conditioning may be carried out under any conditions that are compatible with the materials of this disclosure. For example, the thermal-conditioning may be carried out in any environment, alternatively a partially oxidizing environment, alternatively an inert environment, and alternatively a reducing environment. Such environments are known to one of ordinary skill in the art. For example, the thermal-conditioning may be carried out in the presence of inert gases such as argon or reducing gases such as hydrogen gas, carbon monoxide gas or mixtures of nitrogen and air.

In one embodiment, the thermal-conditioning is carried out in an inert or reducing environment at a temperature of from about 500° C. to about 3000° C., alternatively from about 700° C. to about 1500° C., for from about 0.1 hrs to about 5 hrs. Alternatively, the thermal-conditioning is carried out in a partially oxidizing environment under the disclosed conditions. Thermal-conditioning of the milled particles may result in an increased carbon content. In an embodiment, thermal-conditioning of said milled particles results in a carbon content of greater than about 60 wt. %, alternatively of greater than about 80 wt. %, alternatively of greater than about 95 wt. %. Particles that have been processed through the step represented as block 20 in the FIGURE are hereafter referred to as milled, thermal-conditioned particles.

Referring again to the FIGURE, the method then proceeds to block 30, wherein the milled, thermal-conditioned particles previously described are subjected to a surface treatment. The surface treatment may be designed to produce particles with relatively smooth uniform surfaces that are resistant to fusing together and enable the formation of a smooth-flowing powder. The surface treatment may be described as a process, an embodiment of which is described below.

As is understood by one skilled in the art, the methodologies employed in the surface treatment process are independent of each other and consequently may be contemplated in any order desired by the user. Likewise, the steps may be performed in continuous or batch modes, and it is not necessary that a particular step be completed before a succeeding step is commenced. In a preferred embodiment, the milled, thermal-conditioned particles of this disclosure may be subjected to the process of surface treatment in the order described below.

In certain embodiments, a carbon-yielding material is used to coat the milled, thermal-conditioned particles of this disclosure. This material, hereafter referred to as the coating material, may be any organic compound that can be oxidized and subsequently thermally decomposed in an inert atmosphere at a temperature of 850° C. or higher to form a residue that is “substantially carbon”. It is to be understood that “substantially carbon” indicates that the coating material is at least 85 wt. % carbon. Alternatively, the coating materials are fusible, carbon residue forming materials that are characterized by a high melting point and high carbon yield. Herein a high carbon yield refers to a carbon yield of greater than about 20%, alternatively greater than about 70%, while a high melting point refers to a melting point of greater than about 200° C.

The coating material may be selected from the group consisting of heavy aromatic residues from petroleum, chemical process pitches, coal tar pitches, lignin from pulp processing, phenolic resins and carbohydrate residues such as sugars and polyacrylonitriles. Alternatively, petroleum pitches, coal tar pitches, lignin or combinations thereof may be used.

A preferred process for coating the milled, thermal-conditioned particles of this disclosure entails first forming a concentrated solution of the coating material in a suitable solvent. This solution may be prepared by combining the coating material with a solvent or combination of solvents. The solvent(s) may include any material compatible with the coating material and able to dissolve all or a substantial portion of the coating material. Herein dissolving a substantial portion of the coating material refers to dissolving greater than about 80% of the coating material. In some embodiments, the solvent dissolves portions of the coating material having molecular weights up to at least about 135 g/mole. These solvents may be pure organic compounds or mixtures of such compounds. As will be understood by one skilled in the art, the choice of a solvent will depend on a variety of factors, such as the particular coating material used and temperature.

Examples of solvents that may be employed in solvation of the coating material include without limitation benzene, toluene, xylene, quinoline, tetrahydrofuran, naphthalene, methanol, acetone, tetrahydronapthalene, methyl-pyrrolidione, cyclohexane, water, ether or combinations thereof. In embodiments wherein the coating material is petroleum pitch or coal tar pitch the solvents employed may be selected from the group consisting of toluene, xylene, quinoline, naphthalene, tetrahydronapthalene or combinations thereof. The solvent may be added to the coating material to produce a concentrated solution. The amount of solvent added to the coating material is understood to depend on the amount of coating material and temperature such that the coating material is completely or substantially dissolved in the solvent. In certain embodiments, the solvent to coating material ratio is less than about 4, alternatively less than about 3, alternatively less than about 2 and alternatively less than about 1. In preferred embodiments, the coating material is dissolved in the solvent at a temperature below the boiling point of the solvent.

The solution containing the coating material may be applied to the milled, thermal-conditioned particles of this disclosure using any techniques known in the art. For example, the coating material may be applied to the milled thermal-conditioned particles of this disclosure by mixing the milled, thermal-conditioned particles with the coating material directly. In such embodiments, additional solvent(s) may be added to the resulting mixture to effect partial precipitation of the coating material. The additional solvent may be the same as or different from the solvent employed to initially dissolve the coating material. In some embodiments, the coating material; the milled, thermal-conditioned particles; and the solvent(s) are mixed at a temperature less than about the boiling point of the solvent. The resulting suspension may then be combined with additional coating material solvated in the same or different solvent.

The suspension may then be treated so as to deposit at least a portion of the coating material in a substantially uniform manner on the surface of the milled, thermal-conditioned particles. In an embodiment, the coating material is a petroleum or coal tar pitch. In such an embodiment, the coating material when dissolved in solvent may be precipitated onto the milled, thermal-conditioned particles using any technique known in the art. Alternatively, any technique suitable for the precipitation of the high molecular weight component of the coating material may be employed. Techniques for the precipitation of high molecular weight component from the pitch solution are known to one of ordinary skill in the art and include for example and without limitation the use of a solvent wherein the pitch has reduced solubility or adjusting the ratio of solvent to coating material.

Processes for the introduction of a coating material onto graphite particles have been previously described and are disclosed in detail in U.S. Published Application 2003/016215, which is incorporated by reference in its entirety herein. One technique is to increase the proportion of solvent in the suspension, such that a fraction of the coating material having molecular weights greater that a predetermined value will deposit out of the suspension and onto the particles.

In preferred embodiments, the surface treatment step includes a thermal-chemical treatment after particles are coated with coating materials. Such treatments, also termed stabilization treatments, are known in the art and may be carried out using any methods and under any conditions compatible with the materials of this disclosure and known to one of ordinary skill in the art. For example, the thermal-chemical treatment may include oxidation of the coated particles under oxidizing conditions. Oxidizing conditions are known to one of ordinary skill in the art. Examples of oxidizing conditions include without limitation an oxygen gas atmosphere, contacting the particles with nitrogen oxides, contacting the particles with a liquid and solid oxidizer such as nitrate salt solution and metal oxide and combinations thereof. The thermal-chemical treatment may be carried out at temperature of from about 10° C. to about 500° C., alternatively from about 150° C. to about 400° C.

In preferred embodiments, surface treatment of the milled, thermal-conditioned particles as disclosed herein results in particles with a substantially uniform and smooth carbon-rich surface and a coating level of from about 1% to about 50% by weight, alternatively from about 5% to about 15% by weight of the total weight of the particles. Particles that have been processed through the step represented as block 30 in the FIGURE have a graphitic structure and are hereafter referred to as milled, thermal-conditioned, surface-treated particles.

In certain embodiments, the method concludes at block 40 and the milled, thermal-conditioned, surface treated particles are subjected to graphitization and/or carbonization. Both carbonization and graphitization are thermal treatments. Carbonization functions primarily to increase the carbon:hydrogen ratio of the material, whereas graphitization is designed to promote the formation of the graphitic crystal structure. In an embodiment, carbonization of the milled, thermal-conditioned surface-treated particles is carried out in an inert atmosphere at a temperature of from about 600° C. to about 1500° C., alternatively from about 800° C. to about 1300° C. for from about 0.1 hrs to about 2 hrs. Alternatively, the milled thermal-conditioned, surface-treated particles are graphitized at a temperature of greater than about 2000° C., alternatively greater than about 2500° C., alternatively greater than about 2800° C. for from about 0.1 hrs to about 24 hrs.

In one embodiment, the milled, thermal-conditioned, surface-treated particles are carbonized and subsequently graphitized. In an alternative embodiment, the milled, thermal-conditioned surface-treated particles are graphitized. The choice of carbonization or graphitization of said particles at this point may depend on the previous thermal-conditioning. If previous thermal-conditioning was carried out at temperatures of greater than about 2000° C., the particles may be subjected to carbonization without graphitization. Alternatively, if thermal-conditioning was carried out at temperatures of less than about 2000° C., the particles may be subjected to graphitization and/or carbonization. Such particles having been milled, thermal-conditioned, surface-treated, graphitized and/or carbonized are hereafter referred to as the processed carbon-coated particles. Such processed carbon-coated particles may be of a desirable particle shape having an aspect ratio of less than about 4, alternatively less than about 3, alternatively less than about 2, alternatively less than approximately 1.

The processed carbon-coated particles produced as disclosed herein may be used to form electrodes, such as, for example, the anode material of electrical storage cells or rechargeable batteries. Techniques for the formation of the processed carbon-coated particles of this disclosure into anodes are known to one of ordinary skill in the art. Such anodes may be further used in the construction of rechargeable batteries, alternatively Li-ion batteries. Techniques for the fabrication of said batteries are also known to one of ordinary skill in the art. In an embodiment, a method for the manufacture of an electrochemical storage cell comprises the steps of incorporating into the anode of an electrochemical storage cell the processed carbon-coated particles of this disclosure.

The methodology disclosed herein may produce processed carbon-coated particles having some or all of the following characteristics: an average particle size of less than about 30 μm, an aspect ratio of less than about 4, a carbon coating level of from about 1% to about 50% by total weight and a graphitic structure. A particle subject to the disclosed processing but lacking all of the aforementioned characteristics may be further processed to produce a particle having all of the disclosed characteristics. Methods of further processing the particles to produce these characteristics are known to one of ordinary skill in the art and include without limitation carbonization and/or graphitization.

### EXAMPLES

The invention having been generally described, the following examples are given as particular embodiments of the invention and to demonstrate the practice and advantages thereof. It is understood that the example are given by way of illustration only and are not intended to limit the specification of the claims in any manner.

### Example 1

An ultra-fine graphite powder for use as the anode material in lithium ion batteries was prepared as follows. A green coke powder (ConocoPhillips needle coke) was milled using a jet-mill to make a powder that had an average particle size of about 5 micrometers. The resulting green coke powder was thermal-conditioned by heating it at 600° C. for 2 hours in nitrogen gas environment.

20 grams of the fine powder were dispersed in 100 grams of xylene to form solution A in a sealed stainless steel vessel and heated to 140° C. while the solution was continuously agitated. 32 grams of a petroleum pitch that contained about 10% xylene insoluble pitch was dissolved in 32 grams of xylene completely to form solution B. Solution B was also heated to 140° C. and then poured into solution A and thoroughly mixed together. The resulting solution was heated at 160° C. for 10 minutes and then cooled to room temperature while the solution was continuously agitated. The pitch-coated powder was separated out by filtration and washed twice with 50 ml of xylene and then dried under vacuum. The resulting dry powder weighed 23.5 grams, giving 15% pitch in the powder.

The above powder was spread on a glass dish (about 4 inches in diameter), placed in a furnace, and heated in the following sequences under reduced air pressure (about −15 inch Hg): 5° C./minute to 160° C., 1° C./minute to 250° C. and held at 250° C. for 2 hours, and then 1° C./minute to 280° C., and held at 280° C. for 8 hours, and then cooled to ambient temperature. During the heating, oxygen gas in the air reacts with the coated pitch. As a result, the reacted pitch film on the carbon particles exhibits a reduced tendency to fuse or agglomerate when heated and can develop a desired crystalline structure during subsequent carbonization and graphitization steps.

The above powder was placed in a tube furnace and heated at 800° C. for 2 hours in nitrogen gas and then cooled to room temperature (˜22° C.). The resulting powder was subsequently transferred into an induction furnace and heated at 3000° C. for 45 minutes in argon gas and then cooled to room temperature.

This powder was further evaluated as the anode material for lithium ion batteries in coin cells with lithium metal foil as the other electrode. The powder was processed into a thin film on copper substrate with the composition of 7 wt % polyvinylidene fluoride (PVDF). In preparing the electrode, the graphite powder and a 10 wt % PVDF solution were first thoroughly mixed in the above composition to form uniform slurry. The resulting slurry was cast on a copper foil using a hand doctor-blade. The cast film was then dried on a hot plate at 110° C. for 30 minutes, and subsequently pressed to a density of about 1.3 g/cc through a hydraulic rolling press.

Disks of 1.65 cm² were punched out from the above film and used as the positive electrode in a coin cell for electrochemical tests. The other electrode was lithium metal. A glass matt and a porous polyethylene film (Cellguard™) were used as the separator between the electrode and Li metal foil. Both the electrodes and separator were soaked with 1 M LiPF₆ electrolyte. The solvent for the electrolyte consisted of 40 wt % ethylene carbonate, 30 wt % diethyl carbonate, and 30 wt % dimethyl carbonate. The cells were first charged under a constant current till the cell voltage reached 0 volt and then discharged under a constant current until the cell voltage reached 2.0 volts. The electrical charges passed during charging and discharging were recorded and used to determine the capacity of the graphite powders and the coulombic efficiency for each cycle. All the tests were conducted at room temperature (˜23° C.). The first discharge capacity and coulombic efficiency are given on the first row in Table 1.

### Comparison Example 1

The effects of omitting the thermal-conditioning step were determined. The milled green coke powder in EXAMPLE 1 was first coated with pitch as described in EXAMPLE 1, and subsequently carbonized and graphitized under the same condition. In this example, the thermal-conditioning step in EXAMPLE 1 was omitted. The resulting graphite powder was tested under the same condition as EXAMPLE 1. The test results are listed on the second row in Table 1.

### Comparison Example 2

The effect of the sequence of individual treatment processes described herein for producing ultra-fine graphite powders on the performance of these powders as anode material in a lithium battery was evaluated. In this comparison example, the green coke was first thermal-conditioned, then milled and then graphitized without surface treatment whereas in EXAMPLE 1 the green coke was first milled, then thermal-conditioned, surface treated and then graphitized. The graphite powder produced in this example was tested under the same condition as EXAMPLE 1. The test results are listed on the third row in Table 1.

As shown in Table 1, the discharge capacity of the graphite sample in EXAMPLE 1 was higher than that in COMPARISON EXAMPLE 1, the efficiency of both samples is about the same. However, the efficiency of the sample in COMPARISON EXAMPLE 2 is significantly lower than that of the other two. In addition to the electrochemical properties, a physical property, the tap density of the samples was also measured, as shown in the last column of Table 1. A low tap density material is not as desirable as a high tap density material because it is more difficult to process into electrodes.

Thus, it has been illustrated that the process according to this disclosure carbon-coated particles that are easily processed and have both high discharge capacity and coulombic efficiency as the anode material for lithium ion batteries. Because of the size and shape of the processed ultra-fine graphite powder, they are particularly suitable for high power lithium ion batteries.

TABLE 1

| | Discharge | 1st cycle | |
|---|---|---|---|
| | capacity | Coulombic | Tap density |
| Sample | (mAh/g) | efficiency (%) | (g/cc) |
| Example 1 | 332 | 94.5 | 0.6 |
| Comparison Example 1 | 320 | 94.6 | 0.6 |
| Comparison Example 2 | 310 | 45 | 0.3 |

While preferred embodiments of the invention have been shown and described, modifications thereof can be made by one skilled in the art without departing from the scope of the invention. The embodiments described herein are exemplary only, and are not intended to be limiting. Many variations and modifications of the invention disclosed herein are possible and are within the scope of the invention. For example, where numerical ranges or limitations are expressly stated, such express ranges or limitations should be understood to include incremental ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required; both alternatives are intended to be within the scope of the claim. Use of inclusive terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method for the production of carbon-coated particles comprising:
(a) providing a carbonaceous material;
(b) milling said carbonaceous material and;
(c) thermal-conditioning said carbonaceous material.

2. The method of claim 1 wherein the carbonaceous material has a fixed carbon content of greater than about 25 wt. %.

3. The method of claim 1 wherein the carbonaceous material is selected from the group consisting of petroleum pitches, coal tar pitches, calcined petroleum cokes, uncalcined petroleum cokes, highly crystalline cokes, coal tar cokes, synthetic graphites, natural graphites, soft carbons derived from organic polymers, soft carbons derived from natural polymers and combinations thereof

4. The method of claim 1 wherein the carbonaceous material is selected from the group consisting of infusible coke pitches, uncalcined petroleum cokes, uncalcined tar cokes and combinations thereof.

5. The method of claim 1 wherein the carbonaceous material is milled so as to form particles having an average particle size of less than about 30 μm.

6. The method of claim 1 wherein the carbonaceous material is thermal-conditioned in an inert atmosphere, a reducing atmosphere or a partially oxidizing atmosphere.

7. The method of claim 1 wherein the thermal-conditioning is carried out a temperature of from about 500° C. to about 3000° C.

8. The method of claim 1 wherein thermal-conditioning results in a carbon content of greater than about 60 wt. %

9. The method of claim 1 further comprising a step (d) wherein the carbonaceous material is subjected to a surface treatment.

10. The method of claim 9 wherein step (d) includes surface treating the carbonaceous material with a coating material to provide coated particles.

11. The method of claim 10 wherein the coating material is selected from the group consisting of heavy aromatic residues from petroleum, chemical process pitches, petroleum pitches, coal tar pitches, lignin, phenolic resins, carbohydrate residues and combinations thereof.

12. The method of claim 10 wherein the coating material is selected from the group consisting of petroleum pitch, coal tar pitch, lignin and combinations thereof.

13. The method of claim 10 wherein step (d) includes forming a solution of the coating material and a solvent.

14. The method of claim 13 wherein the coating material is deposited onto the surface of the carbonaceous material by selectively precipitating the coating material onto the particles.

15. The method of claim 13 wherein step (d) further includes increasing the ratio of solvent to coating material so as to cause a desired fraction of the coating material to deposit on the carbonaceous material.

16. The method of claim 13 wherein step (d) further includes introduction of a second solvent to the coating material wherein the coating material has a reduced solubility in said second solvent so as to cause a desired fraction of the coating material to deposit on the carbonaceous material.

17. The method of claim 13 wherein the ratio of solvent to coating material in step (d) is less than about 4.

18. The method of claim 10 wherein the surface treatment includes a thermal-chemical treatment.

19. The method of claim 18 wherein the thermal-chemical treatment comprises
(a) exposing the particles to oxidizing conditions and;
(b) subsequently heating said particles at a temperature of from about 10° C. to about 500° C.

20. The method of claim 1 wherein step (c) is carried out between step (b) and step (d).

21. The method of claim 1 further comprising a step (e) wherein the carbonaceous material is carbonized, graphitized or both.

22. The method of claim 21 wherein carbonizing is carried out in an inert atmosphere at a temperature of from about 600° C. to about 1500° C.

23. The method of claim 21 wherein graphitizing is carried out at a temperature of greater than about 2000° C.

24. A carbon particle having the following characteristics:
a) an average particle size of less than about 30 μm;
b) an aspect ratio of less than about 4;
c) a carbonaceous coating level of from about 1% to about 50% by weight and;
d) a graphitic structure.

25. The particle of claim 24 wherein the particle comprises a carbonaceous material selected from the group consisting of petroleum pitches, coal tar pitches, calcined petroleum cokes, uncalcined petroleum cokes, highly crystalline cokes, coal tar cokes, synthetic graphites, natural graphites, soft carbons derived from organic polymers, soft carbons derived from natural polymers or combinations thereof.

26. A method for the production of a Li-ion battery wherein the particles of claim 24 are used as the anode material.

27. An electrical storage cell comprising the particles of claim 24.

28. The electrical storage cell of claim 27 wherein the electrical storage cell is a rechargeable electrical storage cell.

29. A method for the manufacture of an electrical storage cell comprising incorporating the particles of claim 24 into an anode of the electrical storage cell.

30. A method of producing electrode material for an electrochemical storage cell comprising;
(a) milling a green coke (b) thermal-conditioning said green coke;
(c) surface-treating said thermal-conditioned green coke; and
(d) further processing said green coke to produce carbonaceous particles having an average particle size of 30 μm, an aspect ratio of less than about 4, a carbonaceous coating level of from about 1% to about 50% by weight and a graphitic structure.
